(19) United States
(12) Patent Application Publication
(10) Pub. No.: US 2010/0066712 A1
(43) Pub. Date: Mar. 18, 2010

(54) VIDEO PROCESSING APPARATUS AND VIDEO PROCESSING METHOD

(75) Inventor: Eiichiro TOMONAGA, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/423,683

(22) Filed: Apr. 14, 2009

(30) Foreign Application Priority Data
Sep. 17, 2008 (JP) P2008-237474

(51) Int. Cl. G09G 5/00; G09G 5/10

(52) U.S. Cl. 345/207; 345/690

(57) ABSTRACT

According an aspect of the invention, a video processing apparatus including: a sensor configured to measure an illuminance level; and a processing unit configured to receive a video signal and perform a gamma correction processing on the video signal to correct luminance of the video signal by using a correction value for the illuminance level so that the correction value becomes smaller as the illuminance level gets larger.

### CROSS-REFERENCE TO RELATED APPLICATIONS

This application is based upon and claims the benefit of priority from Japanese Patent Application No. 2008-237474, filed Sep. 17, 2008, the entire contents of which are incorporated herein by reference.

### BACKGROUND

1. Field

The present invention relates to a video processing apparatus and a video processing method.

2. Description of the Related Art

For the prior art, there has been a video processing apparatus for detecting time information and environment specifying information for specifying an environment of a user and correcting image quality of a displayed video based on them (for example, see JP-A-2007-43533).

The video processing apparatus has a time information acquiring portion for acquiring time information, an information acquiring portion for acquiring environment specifying information such as a weather, a control portion for comparing the time information and the environment specifying information with a characteristic amount of an input video signal, thereby calculating a correction value of the video signal, an image quality processing portion for correcting image quality of the video signal based on the correction value, and a display portion for displaying the video signal thus corrected, and can execute a suitable image quality correction for a viewing environment of a user.

According to the conventional video processing apparatus, however, the environment specifying information such as a weather greatly fluctuates depending on an installation condition such as an installation place of the video processing apparatus, for example, whether a living space can easily get an outside light. For this reason, there is a problem in that the conventional video processing apparatus is not suitable for a detailed image quality correction corresponding to the viewing environment of the user. In the case in which the morning, afternoon or night is decided based on the time information, moreover, a time of sunset fluctuates depending on a season or the viewing environment of the user cannot be determined uniquely depending on a latitude of a position in which the video processing apparatus is provided. For this reason, there is a disadvantage in that the conventional video processing apparatus is not suitable for the detailed image quality correction.

Furthermore, a brightness of a video felt by the user depends on an illuminance of the place in which the video processing apparatus is provided (Bartleson—Breneman effect). In other words, in the case in which the illuminance is high, the user feels that a video having the greatest luminance value is relatively dark and feels as if a contrast of a video was reduced (a contrast value of a video signal was decreased). In the case in which the illuminance is low, moreover, the user feels as if the contrast was increased (the contrast value of the video signal was increased) reversely to the case in which a brightness is high. However, the conventional video processing apparatus has a disadvantage in that the image quality correction cannot be executed corresponding to the brightness of the video felt by the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view showing a video processing apparatus according to a first embodiment,

FIG. 2 is an exemplary block diagram showing an example of a structure of the video processing apparatus according to the first embodiment,

FIGS. 3A to 3C are schematic charts showing an example of an operation of the video processing apparatus according to the first embodiment,

FIG. 4 is an exemplary schematic view showing an example of a display of a video display device according to a second embodiment, and

FIG. 5 is an exemplary schematic chart showing an example of an operation of the video display device according to the second embodiment.

### DETAILED DESCRIPTION

Various embodiments according to the invention will be described hereinafter with reference to the accompanying drawings. In general, according to one embodiment of the invention, a video processing apparatus includes: a sensor configured to measure an illuminance level; and a processing unit configured to receive a video signal and perform a gamma correction processing on the video signal to correct luminance of the video signal by using a correction value for the illuminance level so that the correction value becomes smaller as the illuminance level gets larger.

An embodiment of a video processing apparatus and a video processing method according to the invention will be described below in detail with reference to the drawings.

### First Embodiment

### Structure of Video Processing Apparatus

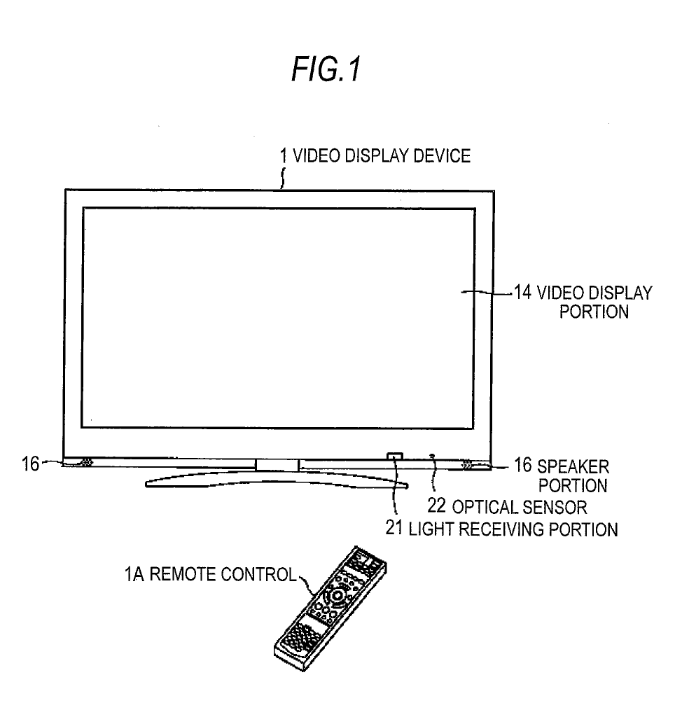

FIG. 1 is a schematic view showing a video processing apparatus according to a first embodiment of the invention.

A video processing apparatus 1 is a television image receptor for receiving a digital broadcast wave from an outside through an antenna which is not shown and displaying a video or receiving a video signal from a video reproducing device such as an HDD (Hard Disc Drive) recorder or a DVD (Digital Versatile Disc) player which is not shown and displaying a video, and includes a video display portion 14 constituted by an LCD (Liquid Crystal Display) panel for displaying a video on a front surface, a speaker portion 16 for outputting a voice, a light receiving portion 21 for receiving an operating signal using an infrared ray which is transmitted from a remote control 1A having a plurality of operating switches, and an optical sensor 22 constituted by a photodiode for measuring an illuminance of an external environment. Moreover, the video processing apparatus 1 has, on a back face, an operating portion with an antenna terminal, an external input terminal and a plurality of switches which are not shown and, in a body, electronic components having a CPU (Central Processing Unit), an RAM (Random Access Memory), an ROM (Read Only Memory) and an HDD which serve to process a video signal or an audio signal and to control each portion.

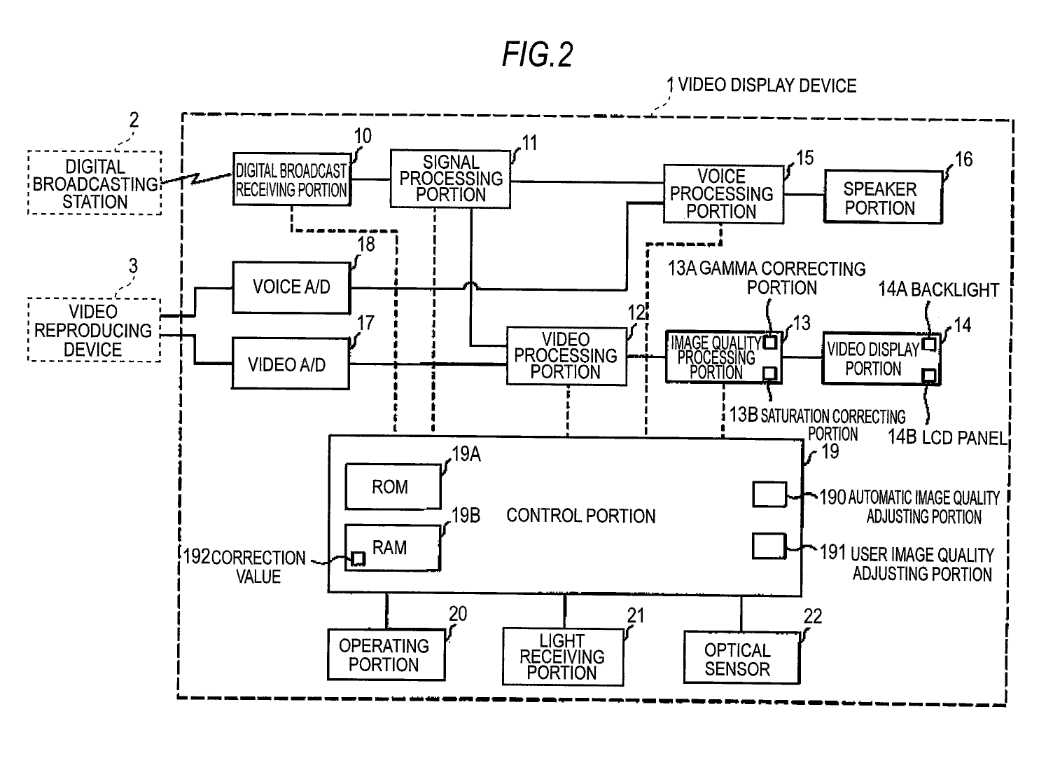

FIG. 2 is a block diagram showing an example of a structure of the video processing apparatus according to the first embodiment of the invention.

The video processing apparatus 1 includes a digital broadcast receiving portion 10 for receiving a broadcast signal transmitted from a digital broadcasting station 2, and the digital broadcast receiving portion 10 is connected to a signal processing portion 11. The signal processing portion 11 is connected to a voice processing portion 15 and a video processing portion 12, and serves to separate the received broadcasting signal into a voice signal and a video signal, and to output the audio signal to the voice processing portion 15 and to output the video signal to the video processing portion 12.

The voice processing portion 15 is connected to the speaker portion 16, and the video processing portion 12 is connected to the video display portion 14 constituted by a CRT or a liquid crystal display panel through an image quality processing portion 13 for adjusting image quality. Moreover, the voice processing portion 15 carries out a tone control for the input audio signal.

The image quality processing portion 13 adjusts image quality of the input video signal and outputs, to the video display portion 14, the video signal subjected to the image quality adjustment. Moreover, the image quality processing portion 13 has a gamma correcting portion 13A and a saturation correcting portion 13B which serve to adjust a display of the video display portion 14. The video display portion 14 has a backlight 14A which is controlled by an inverter to cause a luminance to be variable, and an LCD panel 14B on which a light is irradiated on the backlight 14A to display a video. The video display portion 14 is not restricted to the LCD but a display device such as an organic EL (Electro-Luminescence) display or a CRT (Cathode Ray Tube).

Moreover, the video processing apparatus 1 has a video analog/digital converter (A/D) 17 and a voice A/D 18 which receive a video signal and an audio signal which are transmitted from a video reproducing device 3 connected to an external input terminal (not shown), and the video signal and the audio signal which are input to the video A/D 17 and the voice A/D 18 are converted from analog signals into digital signals and their outputs are connected to the video processing portion 12 and the voice processing portion 15, respectively.

Furthermore, the video processing apparatus 1 has a control portion 19 for controlling each portion through a control line shown in a dotted line of FIG. 2, and an operating portion 20 constituted by an operating switch, the light receiving portion 21 for receiving an operating signal of an infrared ray of the remote control 1A and the optical sensor 22 for measuring an illuminance of an external environment are connected to the control portion 19.

The control portion 19 has an ROM 19A for storing a program to control each portion, an RAM 19B for temporarily storing information and aiding an operation of the control portion 19, an automatic image quality adjusting portion 190 and a user image quality adjusting portion 191.

The RAM 19B stores a correction value 192 obtained by relating the illuminance of the external environment to an image quality adjusting set value which will be described below. The image quality adjusting set value mainly has a gamma correction value and a saturation correction value.

The automatic image quality adjusting portion 190 determines an image quality adjusting set value based on the illuminance of the external environment which is measured by the optical sensor 22 and the correction value 192, and controls the image quality processing portion 13 based on the image quality adjusting set value thus determined. The automatic image quality adjusting portion 190 is operated at a time interval on a unit of a field of video information and adjusts image quality of the video information to be input dynamically. Furthermore, the automatic image quality adjusting portion 190 may determine a tone control set value together with the image quality adjusting set value and may control the voice processing portion 15 based on the tone control set value thus determined.

The user image quality adjusting portion 191 can change image quality adjusting set contents based on an operating signal received in the operating portion 20 or the light receiving portion 21. The details of the change will be described below in a second embodiment.

### (Operation)

An operation of an electronic apparatus according to the embodiment of the invention will be described below with reference to the drawings.

A digital broadcast wave transmitted from the digital broadcasting station 2 is input to the digital broadcast receiving portion 10 through an antenna which is not shown.

In the digital broadcast receiving portion 10, a received signal is demodulated by a demodulator (not shown) corresponding to a demodulating method for a ground wave digital broadcast, and extracts a data string (a transport stream) based on MPEG 2 standards and outputs the data string to the signal processing portion 11, for example.

The data string (the transport stream) input to the signal processing portion 11 is separated into an audio signal (digital) and a video signal (digital) through an MPEG 2 decoder (not shown), for example, and the audio signal is output to the voice processing portion 15 and the video signal is output to the video processing portion 12.

The video processing portion 12 detects a video type of the input video signal (digital), and furthermore, outputs a video type signal to be a result of the detection to the automatic image quality adjusting portion 190.

The automatic image quality adjusting portion 190 controls the image quality processing portion 13 based on the video type signal and determines an image quality adjusting set value based on the illuminance of the external environment which is measured in the optical sensor 22 and the correction value 192.

Next, the image quality processing portion 13 adjusts the image quality of the video signal based on the image quality adjusting set value and then carries out a conversion into an analog signal if needed, and outputs the analog signal to the video display portion 14 constituted by a CRT or an LCD. The gamma correcting portion 13A of the image quality processing portion 13 carries out a gamma correction over a luminance signal of the video signal based on a gamma correction value included in the image quality adjusting set value and the saturation correcting portion 13B corrects a saturation signal of the video signal based on a saturation correction value included in the image quality adjusting set value.

The saturation correcting portion 13B determines the saturation correction value based on the gamma correction value of the gamma correcting portion 13A. The reason is as follows. In the case in which only a correction of the luminance signal is executed, a relationship between a luminance and a color in the video signal to be output is unnatural. For this reason, the saturation correcting portion 13B executes, over the video signal, an equivalent saturation correction to a degree of the gamma correction executed by the gamma correcting portion 13A. For example, if the gamma correction is applied by approximately 10%, the saturation correction is also applied by approximately 10%. The degree of the correction is represented as a gain value of the video signal to be increased or decreased by the correction, for example.

The voice processing portion 15 carries out a processing for converting the input audio signal (digital) into an analog audio signal and outputs the analog audio signal to the speaker portion 16.

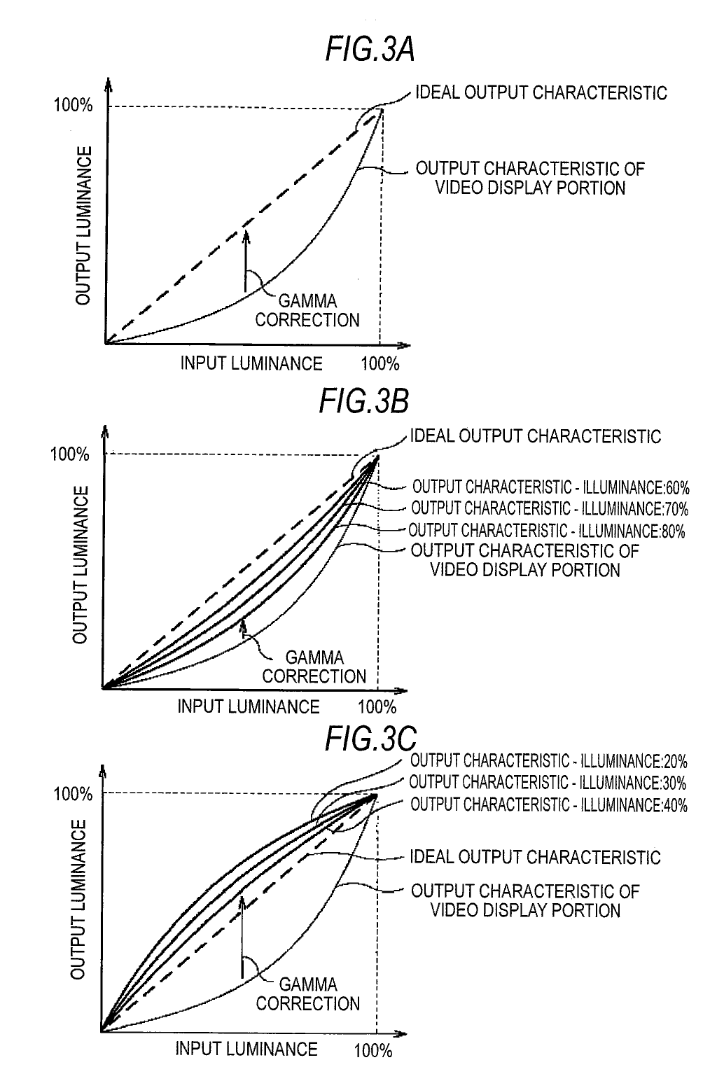

FIGS. 3A to 3C are schematic charts showing an example of the operation of the video processing apparatus according to the first embodiment of the invention.

In the case in which the automatic image quality adjusting portion 190 is not operated, the gamma correcting portion 13A corrects a characteristic of an output luminance of the video display portion 14 with respect to an input luminance of the video signal. As shown in FIG. 3A, the characteristic of the video display portion 14 is shown in a solid line, and the gamma correction is carried out in such a manner that the output luminance takes a linear shape with respect to the input luminance.

In the case in which the automatic image quality adjusting portion 190 is operated, the gamma correcting portion 13A carries out a gamma correction corresponding to the illuminance measured by the optical sensor 22. In the case in which the illuminance measured by the optical sensor 22 is comparatively high, for example, it is equal to or higher than 60% as shown in FIG. 3B, a reverse gamma correction to a normal gamma correction is carried out over an ideal output characteristic. When the illuminance is increased to be 60%, 70%, 80% . . . , moreover, the reverse gamma correction is increased. In other words, a degree of the gamma correction (a correction value of the gamma correction) is reduced. Moreover, it is also possible to execute a gamma correction having a degree reduced with respect to the output characteristic of the video display portion.

In the case in which the illuminance measured by the optical sensor 22 is comparatively low, for example, it is equal to or lower than 40% as shown in FIG. 3C, moreover, the gamma correction is further carried out over the ideal output characteristic. When the illuminance is reduced to be 40%, 30%, 20% . . . , furthermore, the gamma correction is increased. In other words, the degree of the gamma correction is increased. In addition, it is also possible to execute a gamma correction having a degree increased with respect to the output characteristic of the video display portion.

An illuminance to be a reference in an environment using the video display device 1 is preset to be 50%, and an illuminance which is supposed to be the brightest in the using environment is set to be 100% and an illuminance which is supposed to be the darkest is set to be 0%. The user may change the illuminance of 50%.

The saturation correcting portion 13B executes a saturation correction for a degree corresponding to the degree of the gamma correcting portion 13A shown in FIGS. 3B and 3C, thereby causing an output video signal to be proper.

### (Advantage of First Embodiment)

According to the embodiment, the gamma correcting portion 13A executes such a gamma correction as to increase the contrast value of the video signal when the illuminance measured by the optical sensor 22 is high, and executes such a gamma correction as to decrease the contrast value of the video signal when the illuminance is low. Therefore, it is possible to correspond to the change in the contrast which is felt by the user depending on the external environment described by the Bartleson—Breneman effect. The video processing apparatus 1 can execute the optimum image quality adjustment for a viewing environment of the user.

Moreover, the saturation correcting portion 13B carries out the saturation correction corresponding to the degree of the gamma correction of the gamma correcting portion 13A. Therefore, a video signal to be output can be set to be more natural for the user.

The operation of the gamma correcting portion 13A shown in FIGS. 3B and 3C is illustrative, and the degree of the gamma correction can be changed with an identical tendency.

### Second Embodiment

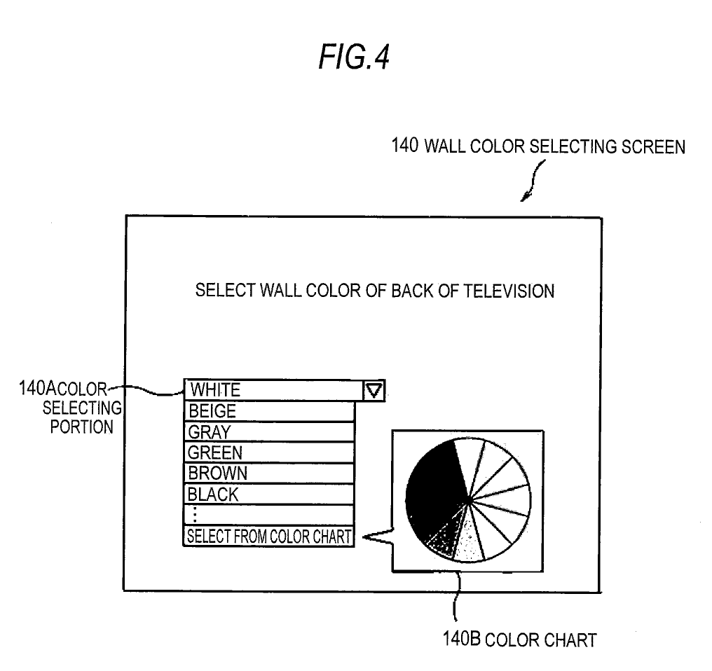

FIG. 4 is a schematic view showing an example of a display of a video display device according to a second embodiment of the invention.

A wall color selecting screen 140 represents contents displayed on a video display portion 14 through a user image quality adjusting portion 191 and includes a color selecting portion 140A for selecting a color of a wall on a back side in an environment in which a video display device 1 is provided and a color chart 140B to be a color sample for directly selecting the same color. A user selects a desirable wall color from the color selecting portion 140A or the color chart 140B, thereby changing a correction value 192.

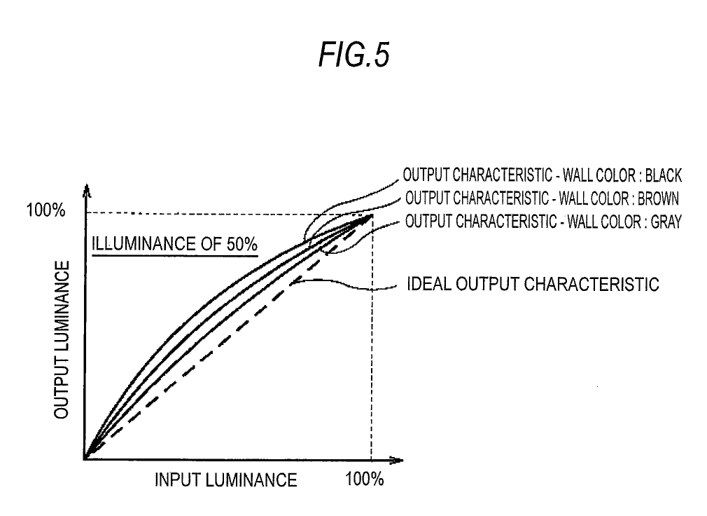

FIG. 5 is a schematic chart showing an example of an operation of the video display device according to the second embodiment of the invention.

In the case in which a correction value is rewritten by the user image quality adjusting portion 191, a gamma correcting portion 13A carries out a gamma correction corresponding to an illuminance measured by an optical sensor 22 through an automatic image quality adjusting portion 190. In the case in which a wall color having a comparatively low optical reflectance is selected over the wall color selecting screen, for example, gray is selected as the wall color as shown in FIG. 5, a gamma correction is further carried out over an ideal output characteristic. When the wall color has an optical reflectance reduced gradually, that is, brown, black, . . . , moreover, the gamma correction is increased. In other words, a degree of the gamma correction is increased. In the case in which the wall color has a high optical reflectance, which is not shown, a reverse gamma correction is executed. In other words, the degree of the gamma correction is reduced.

Moreover, the gamma correcting portion 13A further executes, as a gamma correction in an illuminance of 50%, the gamma correction described in the first embodiment corresponding to the illuminance measured by the optical sensor 22 over an output characteristic determined by the wall color.

### (Advantage of Second Embodiment)

The gamma correcting portion 13A executes such a gamma correction as to decrease a contrast value of a video signal in the case in which the wall color selected in the wall color selecting screen 140 has a low optical reflectance, and executes such a gamma correction as to increase the contrast value of the video signal in the case in which the wall color has a high optical reflectance. Therefore, it is possible to correspond to a change in a contrast which is felt by a user depending on the external environment described by the Bartleson—Breneman effect. The video processing apparatus 1 can execute an optimum image quality adjustment for a viewing environment of the user.

It is also possible to employ a structure in which the optical sensor 22 is provided on the back of the video processing apparatus 1. Consequently, it is possible to measure an illuminance of a background of the video display portion 14 more accurately.

As described with reference to the embodiments, there are provided a video processing apparatus and a video processing method which can execute an optimum image quality adjustment for a viewing environment of a user.

According to the embodiments, it is possible to execute an optimum image quality adjustment for a viewing environment of a user.

1.-13. (canceled)

14. A video processing apparatus comprising:
a sensor configured to measure an illuminance level as an external environment; and
an image-quality processing module configured to:
process to display a wall color selection screen in which a wall color of the external environment is selected;
perform a gamma correction processing, based on the wall color selected in the wall color selection screen,
to decrease a correction value for a luminance signal of an input video signal as compared with a case of being lower than the illuminance level measured by the sensor if the illuminance level measured by the sensor is higher than a predetermined illuminance level, and
to increase the correction value for the luminance signal of the video signal as compared with a case of being higher than the illuminance level measured by the sensor if the illuminance level measured by the sensor is lower than the predetermined illuminance level; and
perform a correction processing on a saturation signal of the video signal based on the gamma correction processing.

15. The video processing apparatus as described in claim 14, wherein the image-quality processing module decreases the correction value in the gamma correction processing as an optical reflection coefficient of the wall color increases.

16. The video processing apparatus as described in claim 14, further comprising a display module configured to display a video signal output from the image-quality processing module.

17. The video processing apparatus as described in claim 16, wherein the sensor is disposed on a face opposite to the display module.

18. A video processing method comprising:
a measuring step of measuring an illuminance level as an external environment;
a display step of processing to display a wall color selection screen in which a wall color of the external environment is selected;
a gamma correction processing step of performing a gamma correction processing, based on the wall color selected in the wall color section screen,
to decrease a correction value for a luminance signal of an input video signal as compared with a case of being lower than the illuminance level measured by the sensor if the illuminance level measured by the sensor is higher than a predetermined illuminance level, and
to increase the correction value for the luminance signal of the video signal as compared with a case of being higher than the illuminance level measured by the sensor if the illuminance level measured by the sensor is lower than the predetermined illuminance level; and
a saturation correction processing process of performing a correction processing on a saturation signal of the video signal based on the gamma correction processing that is performed in the gamma correction processing step.
